(19) United States
(12) Patent Application Publication
(10) Pub. No.: US 2015/0248770 A1
(43) Pub. Date: Sep. 3, 2015

(54) OPTICAL MEASUREMENT METHOD AND OPTICAL MEASUREMENT SYSTEM

(71) Applicant: SUMITOMO ELECTRIC INDUSTRIES, LTD., Osaka-shi (JP)

(72) Inventors: Takemi Hasegawa, Yokohama-shi (JP); Masato Tanaka, Yokohama-shi (JP); Mitsuharu Hirano, Yokohama-shi (JP); Shozo Tonosaki, Yokohama-shi (JP); Takahiro Ueno, Yokohama-shi (JP)

(21) Appl. No.: 14/350,782

(22) PCT Filed: Nov. 14, 2013
(86) PCT No.: PCT/JP13/80817

§ 371 Date: Apr. 9, 2014

(30) Foreign Application Priority Data
Sep. 24, 2013 (JP) 2013-196894

(51) Int. Cl. G06T 7/00; G06K 9/62

(52) U.S. Cl. CPC G06T 7/0085; G06K 9/6267; G06T 2207/10004; G06T 2207/10101; G06T 2210/41; G06T 2207/30024

(57) ABSTRACT

The optical measurement method comprises acquiring a spectrum of interference light produced by interference between back-reflected light from an object to be measured including a plurality of tissues and reference light; creating a two-dimensional reflectance image of the object to be measured according to the spectrum of the interference light; extracting regions occupied by the tissues and a boundary between the tissues in the reflectance image created; setting a range to be analyzed and a spatial averaging range according to the regions and boundary; averaging a concentration distribution of a component obtained in the spatial averaging range including the pixel and taking the average as a concentration of the component at the pixel, so as to calculate a concentration distribution of the component in the tissues; and classifying tissue type according to the extracted regions and concentration distribution, so as to generate a tissue classification image.

### TECHNICAL FIELD

The present invention relates to a method and system for measuring a biological tissue and the like by using the technique of optical coherence tomography (OCT).

### BACKGROUND ART

The optical coherence tomography (OCT) has been known as a technique for measuring a tomographic structure of an object to be measured such as a biological tissue. The OCT is a technology by which back-reflected light occurring when the object to be measured is irradiated with measurement light and reference light having traveled through the reference optical path are caused to interfere with each other, and the resulting interference light is detected and analyzed, so as to measure a reflectance distribution of the measurement light on its optical path.

Performing the OCT measurement by irradiating a vascular wall with measurement light from the vascular lumen by using a catheter incorporating an optical fiber therein and further scanning the inner wall of the blood vessel with the measurement light can measure a reflectance distribution within a cross section of the blood vessel two- or three-dimensionally. The intima, media, and adventitia constituting the blood vessel and the lipid, calcification, and fibrous matters constituting a plaque lesion have respective reflectance distributions different from each other, so that the composition of the plaque is expected to be identifiable from a blood vessel tomographic image obtained by the OCT. Patent Literatures 1 and 2 disclose methods for computing attenuation and backscattering coefficients from the OCT image and classifying the plaque composition according to their values.

Identifying the composition of the plaque and selecting the optimal treatment based thereon can reduce the risk of complications and that of recurrence of the lesion after treatment, thereby improving the vital prognosis of patients.

Since the wavelength spectrum of optical attenuation in the plaque differs from that in normal vascular tissues, using spectroscopic wavelength information is also effective in identifying the composition of the plaque. Patent Literature 3 discloses that the accuracy in identifying the plaque can be enhanced when acquiring spectroscopic wavelength information together with the OCT image by using an optical system common with the OCT.

### CITATION LIST

### Patent Literature

Patent Literature 1: United States Patent No. 7,865,231

Patent Literature 2: Japanese Translated International Application Laid-Open No. 2011-521747

Patent Literature 3: Japanese Translated International Application Laid-Open No. 2009-509694

### Non Patent Literature

Non Patent Literature 1: C. Xu et al. Optics Express Vol. 12, No. 20, pp. 4790-4803 (2004)

Non Patent Literature 2: Z. Wang et al. Journal of Biomedical Optics Vol. 15, No. 6, pp. 061711-1-10 (2010)

### SUMMARY OF INVENTION

### Technical Problem

However, the prior art described in Patent Literature 3 has a problem that the accuracy in measurement of the optical attenuation value is lowered by the speckle noise inherent in the OCT. The speckle noise is a noise resulting from detecting light by interference and randomly modulates the brightness of the OCT image. The optical attenuation value is computed as the gradient of a function of the OCT image brightness with respect to the depth and thus is susceptible to the speckle noise.

For reducing the speckle noise, it has been known effective to average the OCT image brightness spatially. However, the image brightness changes steeply at boundary parts of vascular tissues and plaques, whereby errors will be likely to occur if the averaging is performed in these parts.

For overcoming the problem mentioned above, it is an object of the present invention to provide an optical measurement method and optical measurement system which can reduce the influence of errors caused by the speckle noise of the OCT and highly accurately measure the object to be measured.

### Solution to Problem

The optical measurement method of the present invention comprises the steps of acquiring a spectrum of interference light produced by interference between back-reflected light from an object to be measured including a plurality of tissues and reference light by using an interference optical system; creating a two-dimensional reflectance image of the object to be measured by OCT according to the acquired spectrum of the interference light; extracting respective regions occupied by the plurality of tissues and a boundary between the plurality of tissues in the reflectance image according to a brightness distribution in the reflectance image created; setting a range to be analyzed and a spatial averaging range according to the extracted regions and boundary; averaging, for each pixel within the set range to be analyzed, a concentration distribution of a component obtained by spectral OCT in the spatial averaging range including the pixel and taking the average as a concentration of the component at the pixel, so as to calculate a concentration distribution of the component in each of the plurality of tissues; classifying a kind of the tissue according to the extracted regions and calculated concentration distribution of the component; and generating a tissue classification image according to the classified kind of the tissue.

The optical measurement system of the present invention comprises an interference optical system for measuring a spectrum of interference light produced by interference between back-reflected light from an object to be measured including a plurality of tissues and reference light and an analysis unit for analyzing the spectrum of the interference light; the analysis unit acquiring the spectrum of interference light produced by interference between the back-reflected light from the object and the reference light by using the interference optical system, creating a two-dimensional reflectance image of the object to be measured by OCT according to the acquired spectrum of the interference light, extracting respective regions occupied by the plurality of tissues and a boundary between the plurality of tissues in the reflectance image according to a brightness distribution in the reflectance image created, setting a range to be analyzed and a spatial averaging range according to the extracted regions and boundary, averaging, for each pixel within the set range to be analyzed, a concentration distribution of a component obtained by spectral OCT in the spatial averaging range including the pixel and taking the average as a concentration of the component at the pixel, so as to calculate a concentration distribution of the component in each of the plurality of tissues, classifying a kind of the tissue according to the extracted regions and calculated concentration distribution of the component, and generating a tissue classification image according to the classified kind of the tissue.

Preferably, in the optical measurement method or optical measurement system of the present invention, the interference optical system measures the spectrum of interference light in a wavelength band including 1.0 to 1.75 μm, while the component is a lipid.

### Advantageous Effects of Invention

The present invention can reduce the influence of errors caused by the speckle noise of the OCT and highly accurately measure the object to be measured.

### BRIEF DESCRIPTION OF DRAWINGS

FIG. 1 is a diagram illustrating the structure of an OCT device 1 equipped with an optical probe 10 of an embodiment;

FIG. 2 is a chart illustrating respective transmittance spectra of a lipid lesion, a normal blood vessel, and lard;

FIG. 3 is a chart illustrating a flow of the optical measurement method of an embodiment;

FIG. 4 is a table explaining classifications of kinds of tissues;

FIG. 5 is a chart illustrating a reflectance image created at a reflectance image creation step S2;

FIG. 6 is a chart displaying boundaries extracted at an extraction step S3 as broken lines superposed on an OCT reflectance image;

FIG. 7 is a chart illustrating a range to be analyzed and spatial averaging range for spectroscopic OCT set at a setting step S4;

FIG. 8 is a chart illustrating a region determined to be a lipid as a result of spectroscopic OCT at a calculation step S5; and

FIG. 9 is a chart illustrating results of classifying kinds of tissues at a classification step S6.

### DESCRIPTION OF EMBODIMENTS

In the following, modes for carrying out the present invention will be explained in detail with reference to the drawings. In the explanation of the drawings, the same constituents will be referred to with the same signs while omitting their overlapping descriptions. The present invention is not limited to these illustrations but is indicated by the claims and intends to include all the modifications within the spirit and scope equivalent to the claims.

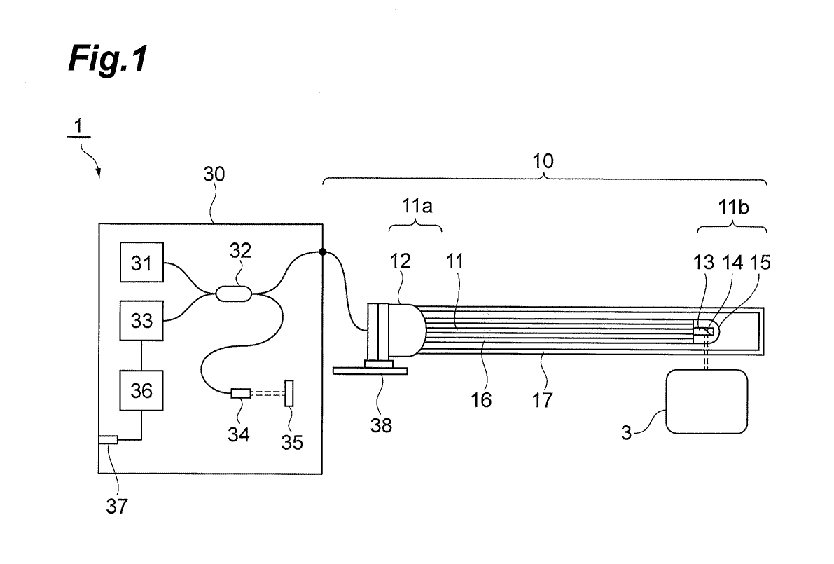

FIG. 1 is a diagram illustrating the structure of an OCT device 1 equipped with an optical probe 10 of an embodiment. The OCT device 1 is an optical measurement system which comprises the optical probe 10 and a measurement unit 30 and acquires an optical coherence tomographic image of an object 3.

The optical probe 10 comprises an optical fiber 11 for transmitting light therethrough between a proximal end 11a and a distal end 11b, an optical connector 12 connected to the optical fiber 11 at the proximal end 11a, a focusing optical system 13 and a deflecting optical system 14 which are optically connected to the optical fiber 11 at the distal end 11b, a cap 15 enclosing the focusing optical system 13 and deflecting optical system 14 therein, and a support tube 16 and a jacket tube 17 which surround the optical fiber 11 and extend along the optical fiber 11.

The optical connector 12 is optically connected to a probe rotary movement mechanism 38 which is a part of the measurement unit 30. The optical fiber 11 has a cutoff wavelength shorter than 1.53 μm. The optical fiber 11, the focusing optical system 13, the deflecting optical system 14, and the cap 15 and jacket tube 17 on an optical path coupled to the fundamental mode of the optical fiber 11 have a light transmittance of −2 dB to 0 dB in the wavelength band of 1.6 to 1.8 μm.

The optical fiber 11 has a length of 1 to 3 m and is constituted by silica glass. The optical fiber 11 has a transmission loss of 2 dB or less, preferably 1 dB or less, in the wavelength band of 1.6 to 1.8 μm and a cutoff wavelength of 1.53 μm or shorter and operates in a single mode in the above-mentioned wavelength range. Preferred as such an optical fiber are optical fibers conforming to ITU-T G652, G654, and G657. The optical fibers conforming to ITU-T G.654A or C are preferred in particular, since they exhibit a low transmission loss of 0.22 dB/km or less at a wavelength of 1.55 μm, typically include a pure silica glass core, and have such a low nonlinear optical coefficient as to be able to reduce the noise caused by nonlinear optical effects such as self-phase modulation.

A graded-index (GRIN) lens as the focusing optical system 13 is fusion-spliced to the distal end 11b of the optical fiber 11. A tilted end face which is formed at the leading end of the GRIN lens reflects light, so as to function as the deflecting optical system 14. By way of the focusing optical system 13 and deflecting optical system 14, light is emitted while converging radially.

The GRIN lens (serving as the focusing optical system 13 and deflecting optical system 14) is constituted by silica glass or borosilicate glass and has a transmission loss of 2 dB or less in the wavelength range of 1.6 to 1.8 μm. A mirror is constructed by cylindrical glass formed with a flat reflecting surface tilted by 35 to 44 degrees with respect to an axis of the GRIN lens. The flat reflecting surface can reflect light by itself, but aluminum or gold is preferably vapor-deposited thereon so as to enhance the reflectance in the wavelength range of 1.6 to 1.8 μm.

The cap 15 is constituted by a urethane acrylate or epoxy resin and has a transmission loss of 2 dB or less in the wavelength range of 1.6 to 1.8 μm. The cap 15 has a refractive index substantially equal to that of the focusing optical system 13 and functions to reduce the reflection by coming into close contact with the focusing optical system 13. The cap 15 also functions to protect the focusing optical system 13 and deflecting optical system 14 mechanically and confine air so as to bring it into contact with an interface of the mirror of the deflecting optical system 14, thereby achieving the mirror by total reflection.

The optical fiber 11 is contained in the bore of the support tube 16. The support tube 16 is secured to a distal end part of the optical fiber 11 and the optical connector 12. As a result, when the optical connector 12 is rotated, the support tube 16 rotates therewith, and a rotation torque is transmitted to the optical fiber 11, whereby the optical fiber 11, focusing optical system 13, deflecting optical system 14, cap 15, and support tube 16 rotate together. This can reduce the torque exerted on the optical fiber 11 and thus can prevent the torque from breaking the optical fiber 11 as compared with the case where the optical fiber 11 is rotated alone.

Preferably, the support tube 16 has a thickness of 0.15 mm or more and a Young's modulus of 100 to 300 GPa which is on a par with that of stainless steel. The support tube 16 is not always required to be circumferentially continuous but may have a structure in which about 5 to 20 lines are yarned, so as to adjust its flexibility.

The optical fiber 11, focusing optical system 13, deflecting optical system 14, cap 15, and support tube 16 are contained in the bore of the jacket tube 17 and adapted to rotate therein. This prevents rotating parts from coming into contact with the object 3 and damaging the latter. Illumination light is emitted from the deflecting optical system 14 and transmitted through the cap 15 and jacket tube 17, so as to irradiate the object 3.

The jacket tube 17 is constituted by a polyamide (nylon or a polyether block amide), fluororesin (FEP, PEFA, PTFE), polyester (PET), or polyolefin (polyethylene or polypropylene), has a thickness of 30 to 100 μm, and exhibits such a transparency as to yield a transmission loss of 2 dB or less in the wavelength range of 1.6 to 1.8 μm. In the OCT measurement, the spatial resolution is typically 30 μm or lower, and the reflections on the inner and outer surfaces of the jacket tube 17 are detected separately and used for calibrating dispersion compensation and the like, whereby it is desirable for the jacket tube 17 to have a thickness greater than the spatial resolution of the OCT measurement.

The bore of the jacket tube 17 is filled with a gas or liquid. Air, nitrogen, carbon dioxide, and the like are preferred as the gas because of their inertness and availability. Silicone oil, saline, and aqueous dextran solutions are preferred as the liquid because they are less harmful to organisms even when leaking out of the jacket tube 17 upon unexpected damages to the probe while in use and the like.

The measurement unit 30 comprises a light source 31 for generating light, an optical splitter 32 for splitting the light emitted from the light source 31 into two and outputting them as illumination light and reference light, a photodetector 33 for detecting light having arrived from the optical splitter 32, an optical terminal 34 for outputting the reference light having arrived from the optical splitter 32, a reflector 35 for reflecting the reference light outputted from the optical terminal 34 to the optical terminal 34, an analysis unit 36 for analyzing a spectrum of the light detected by the photodetector 33, an output port 37 for outputting the result of analysis by the analysis unit 36, and the optical probe rotary movement mechanism 38 for coupling the illumination light having arrived from the optical splitter 32 to the optical probe 10.

In the measurement unit 30, the light emitted from the light source 31 is split into two by the optical splitter 32 and outputted as illumination light and reference light. The illumination light outputted from the optical splitter 32 travels through the optical probe rotary movement mechanism 38 and the optical connector 12, so as to be made incident on the proximal end 11a of the optical fiber 11 and guided therethrough to exit from the distal end 11b, and irradiate the object 3 through the focusing optical system 13, the focusing optical system 14, and the cap 15. The back-scattered light generated upon irradiation of the object 3 with the illumination light is made incident on the distal end 11b of the optical fiber 11 through the cap 15, deflecting optical system 14, and focusing optical system 13 and guided by the optical fiber 11, so as to be emitted from the proximal end 11a and coupled to the photodetector 33 through the optical connector 12, optical probe rotation movement mechanism 38, and optical splitter 32.

The reference light outputted from the optical splitter 32 is emitted from the optical terminal 34 and reflected by the reflector 35, so as to be coupled to the photodetector 33 through the optical terminal 34 and optical splitter 32. The back-reflected light from the object 3 and the reference light interfere with each other in the photodetector 33, and the resulting interference light is detected by the photodetector 33. A spectrum of the interference light is fed into the analysis unit 36. In the analysis unit 36, the spectrum of interference light is analyzed, and a distribution of back-scattering efficiency at individual points within the object 3 is calculated. A tomographic image of the object 3 is computed according to the result of calculation and outputted as an image signal from the signal output port 37.

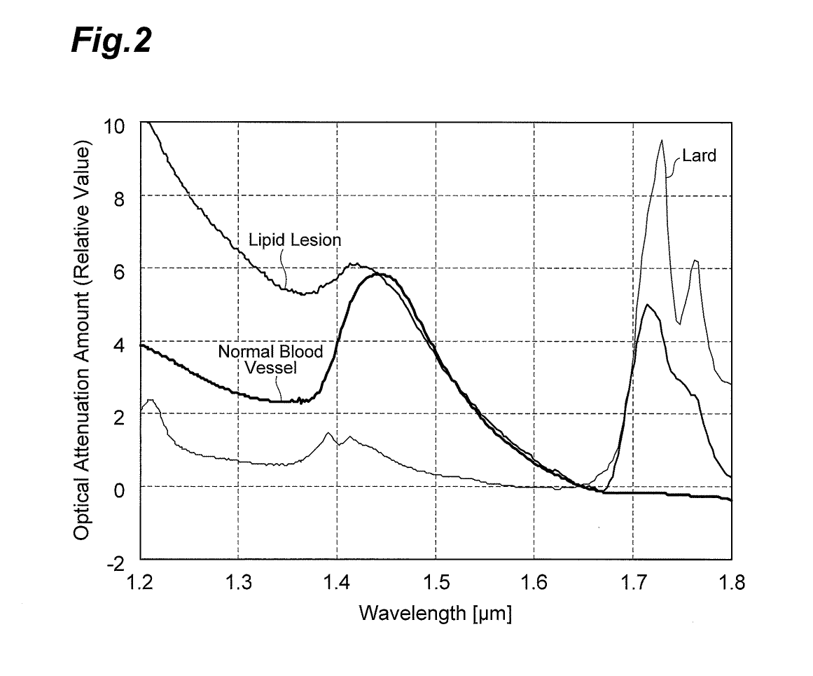

In this embodiment, the light source 31 generates wideband light whose spectrum continuously spreads over the wavelength range of 1.6 to 1.8 μm. In this wavelength range, as FIG. 2 illustrates, a lipid lesion has an absorption peak in the wavelength range of 1.70 to 1.75 μm and differs from normal blood vessels in this point. This peak is attributable to a lipid, since lard, which is a pure lipid, has a similar absorption peak. Therefore, when measuring the object 3 containing a lipid, the spectrum of interference light exhibits, under the influence of absorption by the lipid, a greater attenuation in the wavelength range of 1.70 to 1.75 μm than in its adjacent wavelength ranges.

The spectrum of interference light is modulated not only by the lipid on the optical path of the object 3, but also by interference between the back-reflected light and the reference light. Therefore, analyzing the spectrum of interference light can acquire information of both of the reflectance distribution and lipid distribution in the object 3. Such a technique has been known as spectroscopic OCT and is disclosed in Non Patent Literature 1.

By fitting the result of a Fourier analysis in each of a plurality of bands divided from the spectrum of interference light to a model comprising a wavelength spectrum inherent in a substance acquired beforehand, the spectroscopic OCT can obtain the unknown concentration distribution of the substance. The information of the reflectance distribution can also be acquired by a Fourier analysis of the whole spectrum of interference light. Therefore, the analysis unit 36 can acquire a reflectance distribution image of the object 3 by the normal OCT and a lipid distribution image of the object 3 by performing an analysis according to the spectroscopic OCT.

In the spectroscopic OCT, however, the spectrum of interference light is modulated not only by light absorption due to substances but also by interference between the back-reflected light and the reference light and thus is likely to be susceptible to the speckle noise caused by the interference. As a method for reducing the influence of noise, Non Patent Literature 1 discloses that of introducing a smoothing coefficient. Introducing the smoothing coefficient essentially corresponds to spatial averaging. However, the spatial averaging is problematic in that the effect of averaging is small when the averaging range is too narrow, whereas a plaque may be overlooked if the averaging range is larger than the plaque. When the spatial averaging is applied to a boundary between a plaque and a normal blood vessel, errors may occur in determination by averaging data of different properties.

On the other hand, the normal OCT for imaging the reflectance visualizes tissues having different reflectance values as regions having different brightness values, and a boundary part between the tissues having different reflectance values as a line having a high brightness. Therefore, the reflectance distribution image acquired by the normal OCT can be used for extracting regions of different tissues and boundaries between the tissues. Hence, according to the regions and boundaries of tissues extracted from the reflectance distribution image acquired by the normal OCT, the spectroscopic OCT can perform spatial averaging, so as to set an image range to be analyzed.

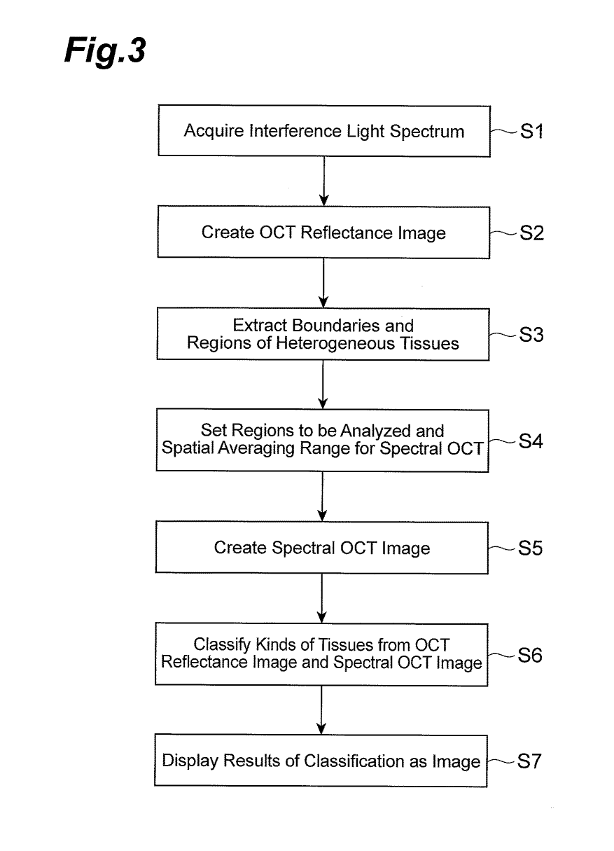

FIG. 3 is a chart illustrating a flow of the optical measurement method of an embodiment. At an acquisition step S1, a spectrum of interference light produced by interference between the back-reflected light from the object 3 including a plurality of tissues and the reference light is acquired by using the interference optical system of the OCT device 1. Based on thus acquired interference light spectrum, the analysis unit 36 performs the following processing according to a program installed therein.

At a reflectance image creation step S2, according to the interference light spectrum acquired at the acquisition step S1, a two-dimensional reflectance image of the object 3 is created by the normal OCT. For creating the reflectance image, the interference light spectrum is subjected to mapping to a wave number space, dispersion compensation processing, and the like, and discrete Fourier transform is performed, so as to create a tomographic image.

At an extraction step S3, according to the brightness distribution in the reflectance image created at the reflectance image creation step S2, respective regions occupied by a plurality of tissues of the object 3 in the reflectance image and boundaries between the plurality of tissues are extracted. For extracting the regions and boundaries, extraction of the boundaries by edge detection processing and segmentation processing for grouping adjacent pieces having closer brightness values and textures into one cluster as a homologous tissue region are performed. These kinds of processing are disclosed in Non Patent Literature 2, for example.

At a setting step S4, according to the regions and boundaries extracted at the extraction step S3, a range to be analyzed and spatial averaging range for calculations at a calculation step S5 subsequent thereto are set. Specifically, a pixel range for spatial averaging is set within a range not exceeding the size of the extracted homologous tissue region. More preferably, 9% to 100% of the area of the homologous tissue region is taken as the spatial averaging range. Below this range, the number of pixels to be averaged becomes smaller, thereby lowering the effect of averaging. Above this range, errors in determination may be caused by mixing and averaging heterogeneous tissues. Performing the spatial averaging in the above-mentioned range can accurately determine properties of tissues while most effectively lowering the influence of noise. According to the extracted boundaries, the pixels corresponding to the boundaries and those acting as centers of spatial averaging ranges including the boundaries are excluded from the object to be analyzed by the spectroscopic OCT, whereby it is not determined whether they are normal or abnormal. This can reduce errors in determination caused by the boundaries.

At the calculation step S5, according to the range to be analyzed and spatial averaging range set at the setting step S4, concentration distributions of components are calculated by the spectroscopic OCT in each of a plurality of tissues. That is, at the calculation step S5, for each pixel within the set range to be analyzed, the concentration distribution of a component obtained by the spectroscopic OCT is averaged in the spatial averaging range including the pixel and taken as the concentration of the component at the pixel, so as to calculate concentration distributions of components in each of the plurality of tissues. Specifically, optical attenuation spectra per unit amount of known substances such as lipids and normal blood vessels are acquired beforehand and kept within the analysis unit 36, and a measured spectrum is resolved into the spectra of known substances by using a method disclosed in Non-Patent Literature 1 or the like, so as to estimate amounts of the known substances. According to the estimated amounts of known substances, a brightness or color is assigned to the pixel, so as to visualize the latter.

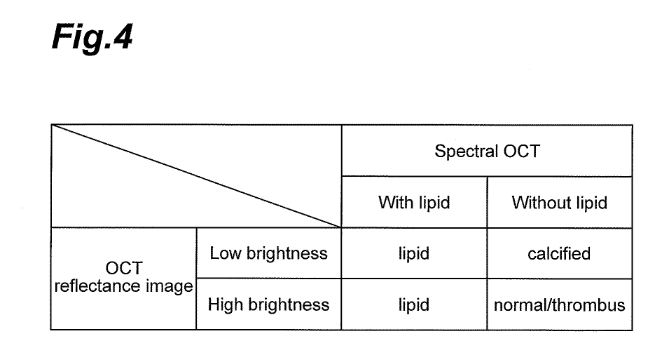

At a classification step S6, according to the regions extracted at the extraction step S3 and the concentration distributions of components calculated at the calculation step S5, kinds of tissues are classified. Specifically, since a lipid can be detected according to its spectroscopic characteristic by the spectroscopic OCT using the wavelength band of 1.7 μm as FIG. 4 illustrates, a region where the lipid is detected by the spectroscopic OCT is classified as the lipid. As for the other regions, since calcified legions have been known to exhibit low brightness in the OCT reflectance image, regions having relatively low brightness are classified as the calcified lesions. While the remaining regions are classified as normal blood vessels, those having such a form as to project into vascular lumens are classified as thrombus. The vascular lumens can be identified at the time of processing for detecting boundaries at the extraction step S3. A classification table for determining classifications of tissues from the reflectance image and results of the spectroscopic OCT are kept in the analysis unit 36.

At a tissue classification image generation step S7, according to the kinds of tissues classified at the classification step S6, a tissue classification image is generated. At this time, different colors, brightness values, and textures are allocated according to the kinds of classified tissues and displayed as an image. A table of correspondences between the kinds of tissues and their display colors, brightness values, and textures is kept within the analysis unit 36. More preferably, a tomographic image indicating a distribution of kinds of tissues is represented substantially simultaneously with a tomographic image of OCT reflectance which has conventionally been familiar to doctors. As a method for representing them at substantially the same time, a method displaying two kinds of images side by side, a method superposing one of the two kinds of images translucently onto the other, and the like are easy to see and favorable. More preferably, a switch for changing display methods is provided on the OCT device or screen and operated so as to switch between a side-by-side display and a superposing display, whereby a viewer can select a method which is easier to view.

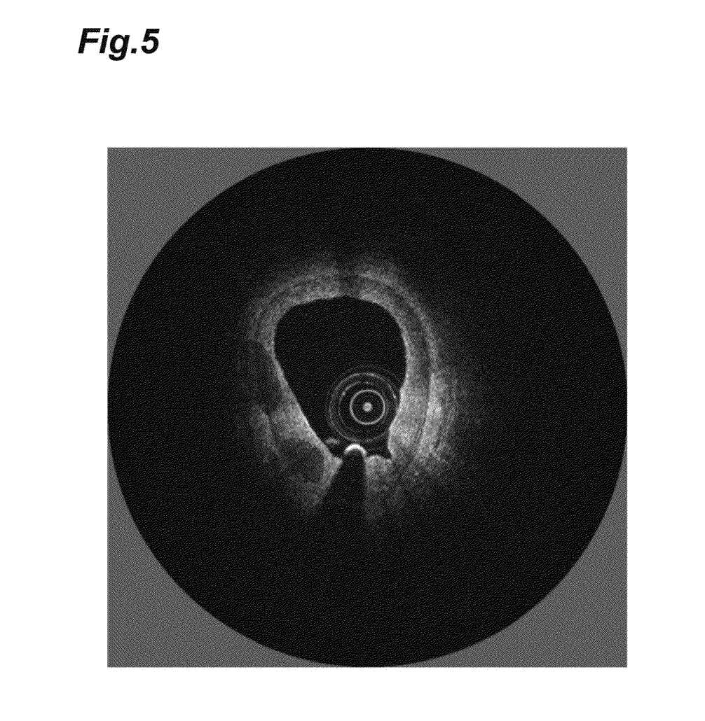

A specific example of measurement in which a blood vessel of a pig is an object to be measured will now be explained with reference to FIGS. 5 to 9. These charts are images in which areas corresponding to lesion parts are artificially processed and added according to an OCT image of the blood vessel of the pig.

FIG. 5 is a chart illustrating the reflectance image created at the reflection image creation step S2. An OCT catheter is located at the center of the image and surrounded by a vascular lumen, which is further surrounded by a vascular wall. The vascular wall, which reflects the measurement light backward and exhibits high reflectance, is displayed with high brightness (white in the chart) in the OCT reflectance image.

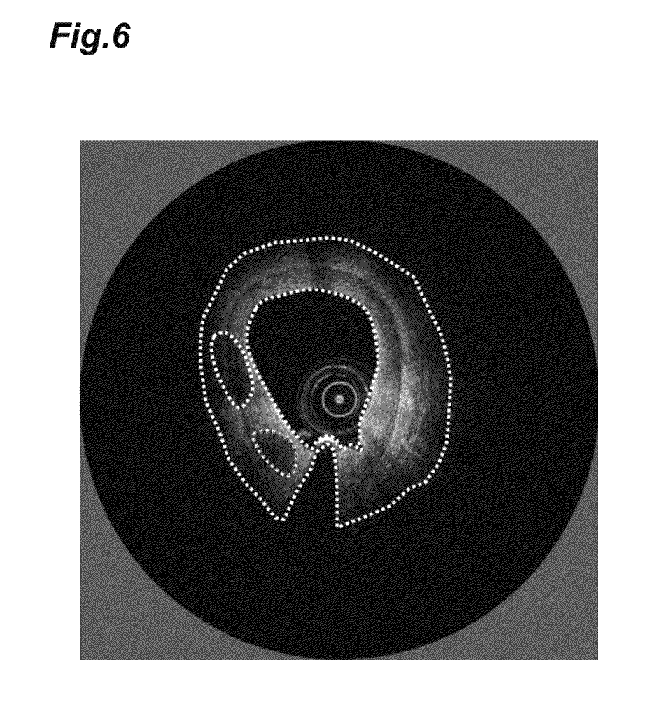

FIG. 6 is a chart displaying the boundaries extracted at the extraction step S3 as broken lines superposed on the OCT reflectance image. The vascular wall surface, where the brightness changes abruptly, is detected as an edge. A position where the OCT signal drops to the noise floor or below in a deep part of the blood vessel is also detected as a boundary because of the difference in brightness between the noise floor and OCT signal. Low-brightness regions located on the lower left and left of the center position are lesion candidate regions, whose boundaries are detected according to changes in brightness.

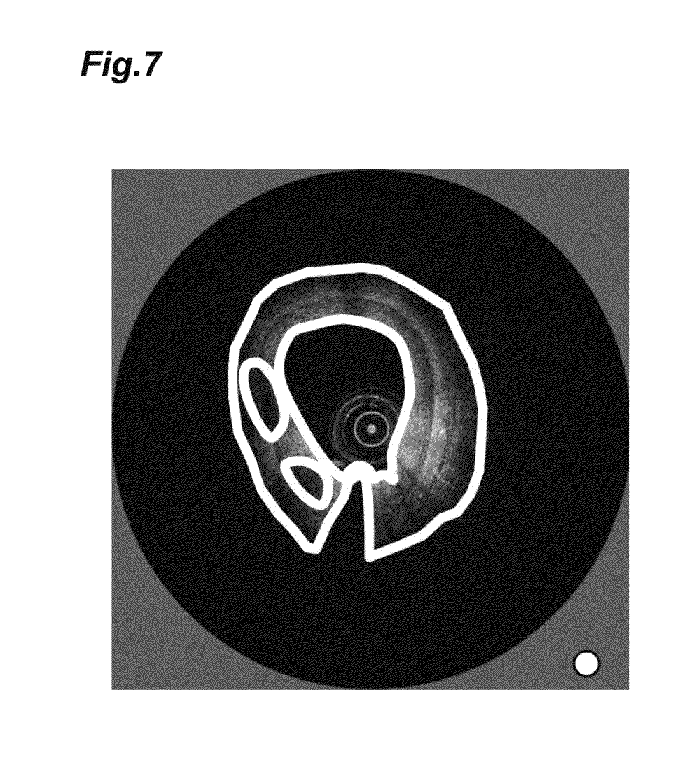

FIG. 7 is a chart illustrating the range to be analyzed and spatial averaging range for spectroscopic OCT set at the setting step S4. The boundaries extracted at the previous step and the areas of ±40 μm on both sides of the boundaries are indicated by thick lines as ranges to be excluded from the analysis range of the spectroscopic OCT. While the spatial resolution of the OCT measurement is typically about 15 μm, the spectroscopic OCT analyzes wavelength dependence by dividing the wavelength band into 5 or so, whereby its spatial resolution coarsens by about 5 times and thus becomes about 75 μm. This makes it preferable to exclude the regions having a width of 80 μm (±40 μm) greater than the spatial resolution about the boundaries from the analysis range of the spectroscopic OCT. On the lower right side of FIG. 7, the size of the spatial averaging range in the spectroscopic OCT is indicated by a circle. This range is set as that of the size by which the lesion candidate extracted at the previous step can be inscribed and occupies about 25% of the area of the lesion candidate region.

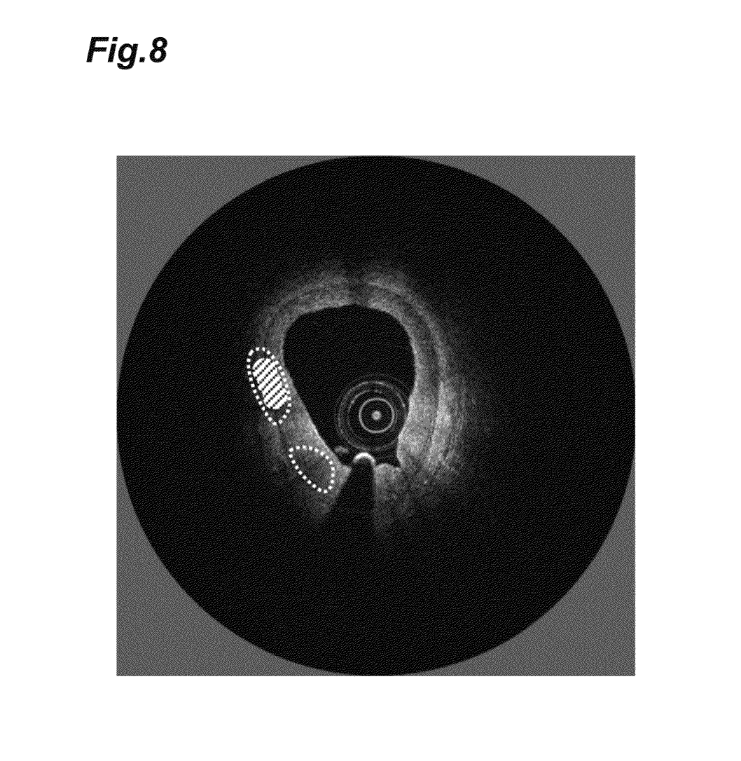

FIG. 8 is a chart illustrating a region determined to be a lipid as a result of the calculation of the spectroscopic OCT at the calculation step S5. The spectroscopic OCT classifies three categories, i.e., lipid, normal blood vessel, and the other (including the regions excluded from the analysis). Among them, the region classified as the lipid is hatched.

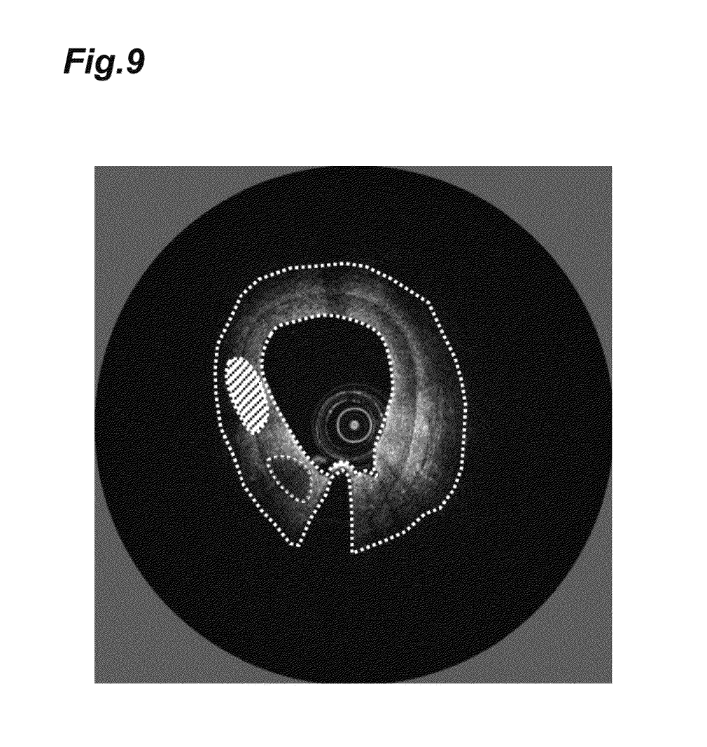

FIG. 9 is a chart illustrating results of classifying kinds of tissues at the classification step S6. In the two regions located on the lower left and left of the center position and extracted as the lesion candidates at the extraction step S3, the former is classified as a calcified lesion, since no lipid is detected in the spectroscopic OCT at the calculation step S5. In the latter, the lipid is detected, whereby the whole of the region extracted as the lesion candidate is classified as a lipid lesion.

As in the foregoing, this embodiment can reduce the influence of errors caused by the speckle noise of the OCT and highly accurately measure the object to be measured. It can also accurately identify lipids and other lesions within biological tissues (vascular tissues in particular).

### REFERENCE SIGNS LIST

1 . . . OCT device; 3 . . . object; 10 . . . optical probe; 11 . . . optical fiber; 11a . . . proximal end; 11b . . . distal end; 12 . . . optical connector; 13 . . . focusing optical system; 14 . . . deflecting optical system; 15 . . . cap; 16 . . . support tube; 17 . . . jacket tube; 30 . . . measurement unit; 31 . . . light source; 32 . . . optical splitter; 33 . . . photodetector; 34 . . . optical terminal; 35 . . . reflector; 36 . . . analysis unit; 37 . . . output port; 38 . . . probe rotary movement mechanism

1. An optical measurement method comprising the steps of:
acquiring a spectrum of interference light produced by interference between back-reflected light from an object to be measured including a plurality of tissues and reference light by using an interference optical system;
creating a two-dimensional reflectance image of the object to be measured by OCT according to the acquired spectrum of the interference light;
extracting respective regions occupied by the plurality of tissues and a boundary between the plurality of tissues in the reflectance image according to a brightness distribution in the reflectance image created;
setting a range to be analyzed and a spatial averaging range according to the extracted regions and boundary;
averaging, for each pixel within the set range to be analyzed, a concentration distribution of a component obtained by spectral OCT in the spatial averaging range including the pixel and taking the average as a concentration of the component at the pixel, so as to calculate a concentration distribution of the component in each of the plurality of tissues;
classifying a kind of the tissue according to the extracted regions and calculated concentration distribution of the component; and
generating a tissue classification image according to the classified kind of the tissue.

2. An optical measurement method according to claim 1, wherein the interference optical system measures the spectrum of interference light in a wavelength band including 1.0 to 1.75 μm; and
wherein the component is a lipid.

3. An optical measurement system comprising an interference optical system for measuring a spectrum of interference light produced by interference between back-reflected light from an object to be measured including a plurality of tissues and reference light and an analysis unit for analyzing the spectrum of the interference light;
the analysis unit acquiring the spectrum of interference light produced by interference between the back-reflected light from the object and the reference light by using the interference optical system,
creating a two-dimensional reflectance image of the object to be measured by OCT according to the acquired spectrum of the interference light,
extracting respective regions occupied by the plurality of tissues and a boundary between the plurality of tissues in the reflectance image according to a brightness distribution in the reflectance image created,
setting a range to be analyzed and a spatial averaging range according to the extracted regions and boundary,
averaging, for each pixel within the set range to be analyzed, a concentration distribution of a component obtained by spectroscopic OCT in the spatial averaging range including the pixel and taking the average as a concentration of the component at the pixel, so as to calculate a concentration distribution of the component in each of the plurality of tissues,
classifying a kind of the tissue according to the extracted regions and calculated concentration distribution of the component, and
generating a tissue classification image according to the classified kind of the tissue.

4. An optical measurement system according to claim 3, wherein the interference optical system measures the spectrum of interference light in a wavelength band including 1.0 to 1.75 μm; and
wherein the component is a lipid.
